(19) United States
(12) Patent Application Publication
(10) Pub. No.: US 2025/0315786 A1
(43) Pub. Date: Oct. 9, 2025

(54) USER INTERFACE FOR DISPLAYING MODEL-BASED PREDICTION OF ORDER FEATURES

(71) Applicant: Maplebear Inc., San Francisco, CA (US)

(72) Inventors: Dustin Neray, Toronto (CA); Calder Hayes, Sundridge (CA); Kevin Charles Ryan, San Francisco, CA (US); Tahmid Shahriar, New York, NY (US)

(21) Appl. No.: 18/626,801

(22) Filed: Apr. 4, 2024

(51) Int. Cl. G06Q 30/0601

(52) U.S. Cl. CPC G06Q 30/0635; G06Q 30/0617

(57) ABSTRACT

An online system manages the availability schedules of fulfillment agents utilizing a favorite order prediction model to predict likelihood of receiving a favorite order. The system receives a request from a fulfillment agent to set an availability schedule for a forthcoming time period. The system applies a prediction model to each of a plurality of discretized time slots of the time period to predict the favorite order likelihood. The model may be trained by the system: retrieving a profile for the fulfillment agent comprising a list of requesting user(s) that have favorited the fulfillment agent, and training the model based on order histories of the list of requesting user(s). The system generates and provides an interface displaying the time slots with a visual indication for each time slot based on its predicted likelihood, e.g., a heat map of likelihoods of receiving a favorite order across the time slots.

### BACKGROUND

In an online system, a requesting user, via a client device, may provide an order comprising a list of items to be obtained at a location by a fulfillment agent. The online system may implement a feature that permits requesting users to favorite fulfillment agents and to select favorited fulfillment agents to complete an order, i.e., a favorite order. A challenge exists in trying to match the fulfillment's user availability with the order timing of the requesting users.

### SUMMARY

An online system fulfills an order placed by a requesting user by dispatching a fulfillment agent to a retail location to obtain items from the order. The online system may implement a feature that permits requesting users to favorite fulfillment agents and to select favorited fulfillment agents to complete an order, i.e., a favorite order. In such embodiments, the online system manages the availability of the fulfillment agents to optimize matching the timing between the fulfillment agents and the requesting users that requested a favorite order for favorited fulfillment agents.

The online system applies a trained prediction model to each of a plurality of discretized time slots of an upcoming time period to predict a likelihood that the fulfillment agent receives a favorite order during the discretized time slot. The fulfillment agent may be favorited by one or more requesting users, which may request a favorite order to be assigned to the fulfillment agent. The trained prediction model may be trained according to the historical order data of the requesting users that have favorited the fulfillment agent. The trained prediction model may be further trained on other contextual data or the fulfillment agent's preference data. The online system generates and provides a scheduling interface that displays the time slots and a visual indication for each time slot based on the predicted likelihood. In one or more embodiments, the visual indications may include color coding the time slots, e.g., to appear like a heat map of likelihoods. The online system may utilize a thresholding filter to determine a color for each time slot. The fulfillment agent may then set their availability schedule through the scheduling interface.

### BRIEF DESCRIPTION OF THE DRAWINGS

FIG. 1A illustrates an example system environment for an online concierge system, in accordance with one or more embodiments.

FIG. 1B illustrates an example system environment for an online concierge system, in accordance with one or more embodiments.

FIG. 2 illustrates an example system architecture for an online concierge system, in accordance with one or more embodiments.

FIG. 3 illustrates a flow diagram of managing availability scheduling for a picker, in accordance with one or more embodiments.

FIG. 4 is a flowchart describing the process of favorite order prediction in the context of picker availability scheduling, in accordance with one or more embodiments.

### DETAILED DESCRIPTION

### Online Concierge System Environment

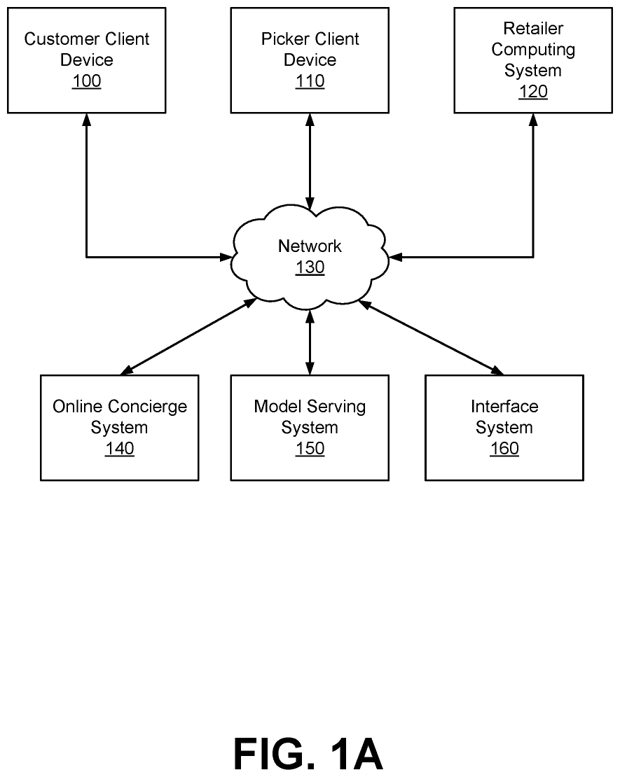

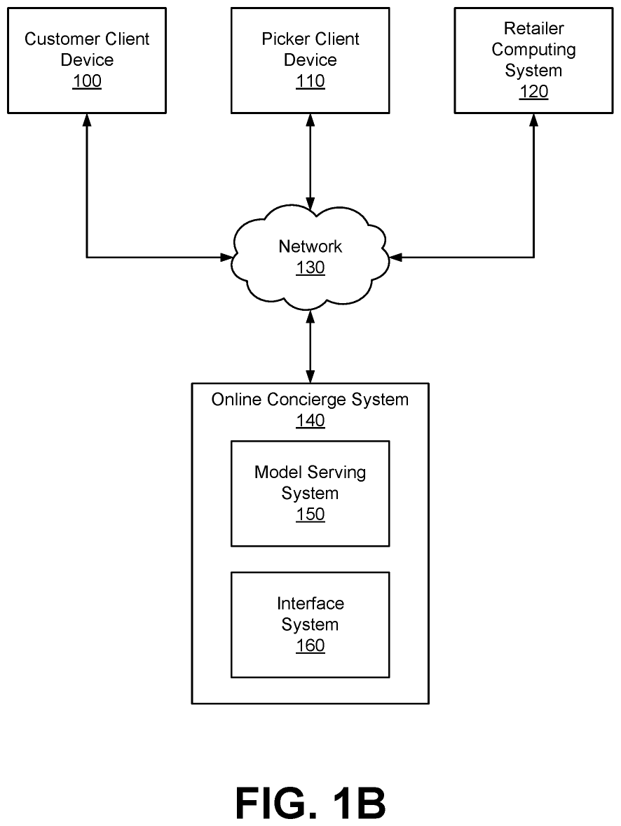

FIG. 1A illustrates an example system environment for an online concierge system 140, in accordance with one or more embodiments. The system environment illustrated in FIG. 1A includes a customer client device 100, a picker client device 110, a retailer computing system 120, a network 130, an online concierge system 140, a model serving system 150, and an interface system 160. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. A customer may also be referred to as a requesting user that provides orders to the online concierge system 140 for fulfillment. An order specifies a set of items to be delivered to the customer. An “item,” as used herein, means a good, a product, or a service that can be provided to the customer through the online concierge system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140. To perform a search, the customer provides a query (e.g., a text query, an audio query, or a visual query) to the online concierge system 140. The online concierge system 140 processes the query to return query results to the customer. Based on the displayed results, the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected. The user interface may also include options to provide input for user preferences. For example, the customer may, via the user interface, provide input tagging one or more items as favorite items. In another example, the customer may, via the user interface, provide input (e.g., in the form of user feedback or user messages) to past orders.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The customer may also select favorite pickers via the customer client device 100. In response to orders completed by certain pickers, the customer may have an option to favorite pickers. Upon favoriting a picker, the online concierge system 140 may update a customer's profile with the favorited picker. Likewise, the online concierge system 140 may update the picker's profile with the favorited association by the customer. In future orders, the customer is presented the option to assign the order to the favorited picker. If the customer proceeds with assigning the order to the favorited picker, that order is deemed a favorite order.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker may also be referred to as a fulfillment agent that fulfills orders by the requesting user. Items in the order may be presented in a particular sequence (i.e., display order) to optimize efficiency of the picker. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer, so that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

The picker client device 110 may also provide a communication interface to the picker, e.g., to communicate with another user of the online concierge system 140. For example, the communication interface of the picker client device 110 may present messages from a customer client device 100 to the picker client device 110. Such communication may be utilized when items in an order are unavailable at the retailer location. In such scenarios, the picker may query the customer for suitable substitution items to be obtained for the unavailable item. The messages may be in the form of text, audio, pictures, other digital manners of communicating information, etc.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

The picker may, through the picker client device 110, choose to remove favorited customers from their profile. For example, although one customer may favorite one picker, the picker's sentiments may not be reciprocal to that of the customer. Accordingly, the picker can choose to remove themselves from being a favorited picker by the customer.

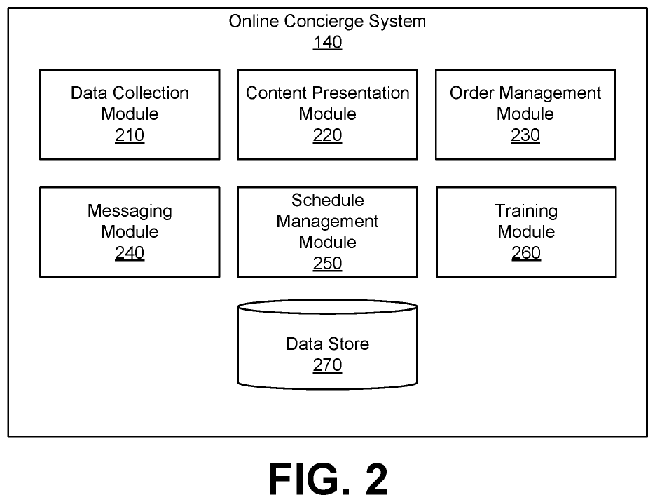

The picker may, through the picker client device 110 update their availability schedule in upcoming time periods. For example, every week, the picker may input an availability schedule for the upcoming week. In such embodiments, the online concierge system 140 provides a scheduling interface to the picker client device 110 to aid in the scheduling. The online concierge system 140 may further implement a favorite order prediction model to predict the likelihood that the picker will be assigned an order as a favorited picker by the customer. Details relating to the favorite order prediction model are further described in FIGS. 2-4.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The retailer computing system 120 may provide the online concierge system 140 with retailer data describing the retailer associated with the retailer computing system 120. The retailer data may include retailer name, retailer address, retailer website, retailer phone number, other identifying information, a type of retailer, an expense class of the retailer (e.g., $, $$, or $$$), opening hours, general dependability of items, diversity of items, types of items carried, or information describing the retailer, or some combination thereof. The online concierge system 140 may further infer additional retailer data based on interactions between customers or shoppers and the retailer. For example, such retailer data based on the interactions may include customer reviews, shopper reviews, popular items ordered, dependability of items, etc.

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provide portions of the payment from the customer to the picker and the retailer.

As an example, the online concierge system 140 may allow a customer to order groceries from a grocery store retailer. The customer's order may specify which groceries they want delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140.

The model serving system 150 receives requests from the online concierge system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are language models configured to perform one or more NLP tasks. The NLP tasks include, but are not limited to, text generation, query processing, machine translation, chatbots, and the like. In one or more embodiments, a language model of the model serving system 150 is configured as a transformer neural network architecture (i.e., a transformer model). Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. The language model can be configured as any other appropriate architecture including, but not limited to, transformer-based networks, long short-term memory (LSTM) networks, Markov networks, BART, generative-adversarial networks (GAN), diffusion models (e.g., Diffusion-LM), and the like.

In one or more embodiments, the task for the model serving system 150 is based on knowledge of the online concierge system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online concierge system 140 is connected to an interface system 160. The interface system 160 receives external data from the online concierge system 140 and builds a structured index over the external data using, for example, another machine-learned language model or heuristics. The interface system 160 receives one or more queries from the online concierge system 140 on the external data. The interface system 160 constructs one or more prompts for input to the model serving system 150. A prompt may include the query of the user and context obtained from the structured index of the external data.

In one instance, the context in the prompt includes portions of the structured indices as contextual information for the query. The interface system 160 obtains one or more responses from the model serving system 150 and synthesizes a response to the query on the external data. While the online concierge system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources.

FIG. 1B illustrates an example system environment for an online concierge system 140, in accordance with one or more embodiments. The system environment illustrated in FIG. 1B includes a customer client device 100, a picker client device 110, a retailer computing system 120, a network 130, and an online concierge system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online concierge system 140. In one or more embodiments, as illustrated in the example system environment in FIG. 1B, the model serving system 150 and/or the interface system 160 is managed and deployed by the entity managing the online concierge system 140. The online concierge system 140 is described in further detail below with regards to FIG. 2.

### Online Concierge System Architecture

FIG. 2 illustrates an example system architecture for an online concierge system 140, in accordance with some embodiments. The system architecture illustrated in FIG. 2 includes a data collection module 210, a content presentation module 220, an order management module 230, a messaging module 240, a schedule management module 250, a training module 260, a data store 270, a prompt generation module 260, and a ranking module 260. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 210 collects data used by the online concierge system 140 and stores the data in the data store 270. The data collection module 210 may only collect data describing a user if the user has previously explicitly consented to the online concierge system 140 collecting data describing the user. Additionally, the data collection module 210 may encrypt all data, including sensitive or personal data, describing users.

For example, the data collection module 210 collects customer data, which is information or data that describe characteristics of a customer. Customer data may include a customer's name, address, other demographic information (e.g., age range, family size, dietary restrictions or preferences, etc.), shopping preferences (e.g., shopping frequency, shopping magnitude, etc.), previous orders, favorite items, favorite types of items, favorite retailers, favorite pickers, repeat pickers, or stored payment instruments. The customer data also may include default settings established by the customer, such as a default retailer/retailer location, payment instrument, delivery location, or delivery timeframe. The customer data may also include user preference data indicating one or more preferences, e.g., provided by the user and/or inferred by the online concierge system 140. The data collection module 210 may collect the customer data from sensors on the customer client device 100 or based on the customer's interactions with the online concierge system 140.

The data collection module 210 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the dependability of items in retailer locations, also referred to as “dependability.” For example, for each item-retailer combination (a particular item at a particular warehouse), the item data may include a time that the item was last found, a time that the item was last not found (a picker looked for the item but could not find it), the rate at which the item is found, or the popularity of the item. The data collection module 210 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 210 also collects picker data, which is information or data that describes characteristics of pickers. For example, the picker data for a picker may include the picker's name, the picker's location, how often the picker has serviced orders for the online concierge system 140, a customer rating for the picker, a number of customers that have favorited the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, payment information by which the picker is to be paid for servicing orders (e.g., a bank account), feedback from the picker in fulfilling customer orders, etc. The data collection module 210 collects picker data from sensors of the picker client device 110 or from the picker's interactions with the online concierge system 140.

Additionally, the data collection module 210 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 220 selects content for presentation to a user. For example, the content presentation module 220 selects which items to present to a customer while the customer is placing an order. The content presentation module 220 generates and transmits an ordering interface for the customer to order items. The content presentation module 220 populates the ordering interface with items that the customer may select for adding to their order. In some embodiments, the content presentation module 220 presents a catalog of all items that are available to the customer, which the customer can browse to select items to order. The content presentation module 220 also may identify items that the customer is most likely to order and present those items to the customer. For example, the content presentation module 220 may score items and rank the items based on their scores. The content presentation module 220 displays the items with scores that exceed some threshold (e.g., the top n items or the p percentile of items).

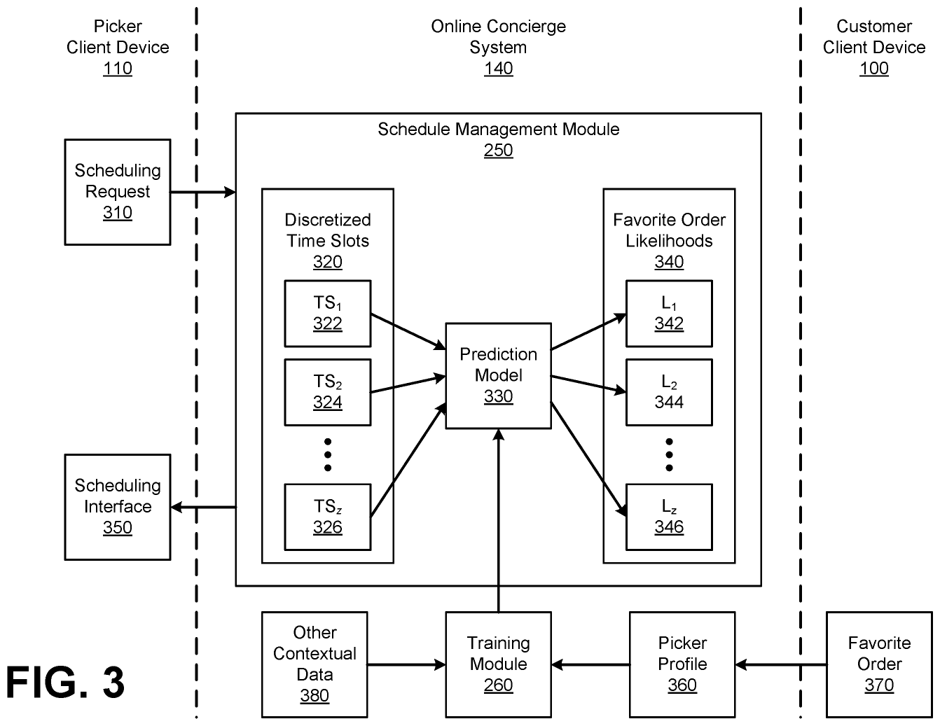

The content presentation module 220 may use a scoring function to score items for presentation to a customer. The scoring function may score items for a customer based on item data for the items and customer data for the customer. The scoring function may determine a ranking score based on ranking parameter values for each item and a weight vector. The weight vector may be output by a contextual bandit model (e.g., as further described in FIGS. 3 & 5). In some embodiments, an item selection model trained as a machine-learning model may determine a likelihood that the customer will order the item. In some embodiments, the item selection model uses item embeddings describing items and customer embeddings describing customers to score items. These item embeddings and customer embeddings may be generated by separate machine-learning models and may be stored in the data store 270.

The content presentation module 220 may further provide, in the ordering interface, an option to assign an order to a favorite picker. The ordering interface may indicate a next availability for the favorite picker. In so doing, the order interface provides flexibility if the customer wants to prioritize the favorite picker over timing convenience, or would prefer to prioritize timing, e.g., as soon as possible.

The order management module 230 manages orders for items from customers. The order management module 230 receives orders from a customer client device 100 and assigns the orders to pickers for service based on picker data. For example, the order management module 230 assigns an order to a picker based on the picker's location and the location of the retailer from which the ordered items are to be collected. The order management module 230 may also assign an order to a picker based on how many items are in the order, a vehicle operated by the picker, the delivery location, the picker's preferences on how far to travel to deliver an order, the picker's ratings by customers, or how often a picker agrees to service an order. In embodiments where the customer has selected a favorite picker, the order management module 230 may directly transfer the order to the picker, via the picker's client device 110.

In some embodiments, the order management module 230 determines when to assign an order to a picker based on a delivery timeframe requested by the customer with the order. The order management module 230 computes an estimated amount of time that it would take for a picker to collect the items for an order and deliver the ordered items to the delivery location for the order. The order management module 230 assigns the order to a picker at a time such that, if the picker immediately services the order, the picker is likely to deliver the order at a time within the requested timeframe. Thus, when the order management module 230 receives an order, the order management module 230 may delay in assigning the order to a picker if the requested timeframe is far enough in the future (i.e., the picker may be assigned at a later time and is still predicted to meet the requested timeframe).

When the order management module 230 assigns an order to a picker, the order management module 230 transmits the order to the picker client device 110 associated with the picker, e.g., with the content presentation module 220. The order management module 230 may also transmit navigation instructions from the picker's current location to the retailer location associated with the order. If the order includes items to collect from multiple retailer locations, the order management module 230 identifies the retailer locations to the picker and may also specify a sequence in which the picker should visit the retailer locations.

The order management module 230 may track the location of the picker through the picker client device 110 to determine when the picker arrives at the retailer location. When the picker arrives at the retailer location, the order management module 230 transmits the order to the picker client device 110 for display to the picker. As the picker uses the picker client device 110 to collect items at the retailer location, the order management module 230 receives item identifiers for items that the picker has collected for the order. In some embodiments, the order management module 230 receives images of items from the picker client device 110 and applies computer-vision techniques to the images to identify the items depicted by the images. The order management module 230 may track the progress of the picker as the picker collects items for an order and may transmit progress updates to the customer client device 100 that describe which items have been collected for the customer's order.

In some embodiments, the order management module 230 tracks the location of the picker within the retailer location. The order management module 230 uses sensor data from the picker client device 110 or from sensors in the retailer location to determine the location of the picker in the retailer location. The order management module 230 may transmit, to the picker client device 110, instructions to display a map of the retailer location indicating where in the retailer location the picker is located. Additionally, the order management module 230 may instruct the picker client device 110 to display the locations of items for the picker to collect, and may further display navigation instructions for how the picker can travel from their current location to the location of a next item to collect for an order.

The order management module 230 determines when the picker has collected all of the items for an order. For example, the order management module 230 may receive a message from the picker client device 110 indicating that all of the items for an order have been collected. Alternatively, the order management module 230 may receive item identifiers for items collected by the picker and determine when all of the items in an order have been collected. When the order management module 230 determines that the picker has completed an order, the order management module 230 transmits the delivery location for the order to the picker client device 110. The order management module 230 may also transmit navigation instructions to the picker client device 110 that specify how to travel from the retailer location to the delivery location, or to a subsequent retailer location for further item collection. The order management module 230 tracks the location of the picker as the picker travels to the delivery location for an order, and updates the customer with the location of the picker so that the customer can track the progress of the order. In some embodiments, the order management module 230 computes an estimated time of arrival of the picker at the delivery location and provides the estimated time of arrival to the customer.

The order management module 230 coordinates payment by the customer for the order. The order management module 230 uses payment information provided by the customer (e.g., a credit card number or a bank account) to receive payment for the order. In some embodiments, the order management module 230 stores the payment information for use in subsequent orders by the customer. The order management module 230 computes a total cost for the order and charges the customer that cost. The order management module 230 may provide a portion of the total cost to the picker for servicing the order, and another portion of the total cost to the retailer. The order management module 230 may further provide an option to the customer to provide a tip to the picker, e.g., for outstanding service.

The messaging module 240 facilitates communication between the customer client device 100 and the picker client device 110. As noted above, a customer may use a customer client device 100 to send a message to the picker client device 110. The messaging module 240 receives the message from the customer client device 100 and transmits the message to the picker client device 110 for presentation to the picker. The picker may use the picker client device 110 to send a message to the customer client device 100 in a similar manner. Communications between the customer and the picker may be provided to the content presentation module 220 in scoring items for a customer.

The schedule management module 250 aids in managing the pickers' availability schedule. The schedule management module 250 may provide a scheduling interface to the picker's client device 110 with discretized time slots for an upcoming time period. For example, a picker may be prompted by the schedule management module 250 to update their availability every week, wherein the week is partitioned into 1-hr, 2-hr, or 4-hr blocks.

The schedule management module 250 may implement a favorite order prediction model that is specifically trained to each picker. The favorite order prediction model is configured to predict the likelihood that the picker is assigned a favorite order from a customer that has favorited the picker during a time slot in the upcoming period. The schedule management module 250 may apply the favorite order prediction model to each discretized time slot to predict a likelihood for each discretized time slot.

The schedule management module 250 may generate the scheduling interface to provide visual indications based on the predicted likelihoods. For example, the scheduling interface may illustrate the discretized time slots in the upcoming time period with the predicted likelihood annotated on the time slots. The schedule management module 250 may also apply a thresholding filter to the predicted likelihoods to color code the time slots in the scheduling interface. For example, time slots with a predicted likelihood above 75% may appear as green, while time slots with a predicted likelihood above 50% may appear as yellow, and remaining time slots with a predicted likelihood below 50% may appear as red. Other gradations may be used. In effect, the scheduling interface may appear as a heat map visually directing the picker to consider the optimal time slots (i.e., the time slots with the highest likelihoods). In other embodiments, the schedule management module 250 may otherwise visually distinguish the optimal time slots, e.g., animating the time slot, increasing a size of the time slot, etc.

Through the scheduling interface, the picker may set their availability in the upcoming time period. For example, the picker may tap on the discretized time slots that they will be available for fulfillment of order as displayed in the scheduling interface on the picker client device 110. Based on the selection, the schedule management module 250 may update the picker's availability schedule for the upcoming period.

In some embodiments, the schedule management module 250 may utilize the favorite order prediction model to prompt the picker to update their availability schedule. If, after the picker has already set their availability schedule, the model predicts that the likelihood of one time slot has changed, the schedule management module 250 may provide a notification to the picker client device 110 to provide an option to update their availability schedule. For example, if a time slot that the picker indicated unavailable is subsequently predicted to have a high likelihood of being favorited, then the schedule management module 250 may notify the picker of that update. Complementarily, if the schedule management module 250 identifies that a time slot that the picker is currently available suddenly drops in likelihood of being favorited, the schedule management module 250 may notify the picker of such change.

The training module 260 trains machine-learning models used by the online concierge system 140. For example, the training module 260 may train the item selection model, the dependability model, the query processing model(s), the favorite order prediction model, or any of the machine-learned models deployed by the model serving system 150. The online concierge system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The training module 260 generates the set of parameters (e.g., the particular values of the parameters) for a machine-learning model by “training” the machine-learning model. Once trained, the machine-learning model uses the set of parameters to transform inputs into outputs.

The training module 260 trains a machine-learning model based on a set of training examples. Each training example includes input data to which the machine-learning model is applied to generate an output. For example, each training example may include customer data, picker data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The training module 260 may apply an iterative process to train a machine-learning model whereby the training module 260 updates parameter values of the machine-learning model based on each of the set of training examples. The training examples may be processed together, individually, or in batches. To train a machine-learning model based on a training example, the training module 260 applies the machine-learning model to the input data in the training example to generate an output based on a current set of parameter values. The training module 260 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross-entropy loss function. The training module 260 updates the set of parameters for the machine-learning model based on the score generated by the loss function. For example, the training module 260 may apply gradient descent to update the set of parameters.

In one or more embodiments of the favorite order prediction model, the training module 260 may train the model utilizing a combination of inputs. One input may be the picker's user profile, which may include a list of one or more customers that have favorited the picker. The training data may further include characteristics of the customers in that list, characteristics of orders placed by customers in that list, characteristics of the interaction between the picker and list of customers when fulfilling orders, customer feedback relating to previously completed favorite orders, other historical orders fulfilled by the picker for customers that have not favorited the picker, other historical orders fulfilled by other pickers at the same retailer location(s), general supply and demand trends across the discretized time slots, etc.

The data store 270 stores data used by the online concierge system 140. For example, the data store 270 stores customer data, retailer data, item data, order data, and picker data for use by the online concierge system 140. The data store 270 also stores trained machine-learning models trained by the training module 260. For example, the data store 270 may store the set of parameters for a trained machine-learning model on one or more non-transitory, computer-readable media. The data store 270 uses computer-readable media to store data, and may use databases to organize the stored data.

With respect to the machine-learned models hosted by the model serving system 150, the machine-learned models may already be trained by a separate entity from the entity responsible for the online concierge system 140. In one or more other embodiments, when the model serving system 150 is included in the online concierge system 140, the training module 260 may further train parameters of the machine-learned model based on data specific to the online concierge system 140 stored in the data store 270. As an example, the training module 260 may obtain a pre-trained transformer language model and further fine tune the parameters of the transformer model using training data stored in the data store 270. The training module 260 may provide the model to the model serving system 150 for deployment.

### Picker Schedule Management

FIG. 3 illustrates a flow diagram of high touch item handling, in accordance with one or more embodiments. The online concierge system 140 applies a favorite order prediction model 330 to determine a likelihood that the picker receives during the discretized time slot a favorite order from a customer that has favorited the picker. Based on the predicted likelihoods, the schedule management module 250 may generate a scheduling interface with visual indications based on the predicted likelihoods.

The picker client device 110 provides a scheduling request 310 to the online concierge system 140. The scheduling request indicates that the picker wants to set their availability for an upcoming time period. The upcoming time period is discretized into a plurality of time slots. For example, the picker may need to set their availability each week, which may be partitioned into discrete 2-hr blocks. In the illustrative example of FIG. 3, the upcoming time period is discretized into a plurality of time slots 320, i.e., Time Slot 1 (TS₁) 322, Time Slot 2 (TS₂) 324, through Time Slot z (TS_{z}) 326.

The schedule management module 250 manages the picker's availability schedule. The schedule management module 250 applies the favorite order prediction model 330 to each discretized time slot to predict a likelihood that the picker receives a favorite order during that time slot. For example, the favorite order prediction model 330 predicts a first likelihood (L₁) 342 for TS₁ 322, a second likelihood (L₂) 344 for TS₂ 324, and so on through a z^{th} likelihood (L_{z}) for TS_{z} 326. The favorite order likelihoods 340 may be a value from the range of [0, 1] or a percentage from the range of [0%, 100%]. The schedule management module 250 may generate a scheduling interface 350 with the discretized time slots 320 and visual indications based on the favorite order likelihoods 340. In one or more embodiments, the schedule management module 250 may color code the discretized time slots 320 in the scheduling interface 350 to create a heat map based on the favorite order likelihoods 340. Through the scheduling interface, the picker may set their availability in the upcoming time period.

The training module 260 may train the favorite order prediction model 330. The training module 260 may train the favorite order prediction model 330 based on the data retrieved from the picker profile 360 associated with the picker. The data may include data on historical orders fulfilled for customers, including customers that may have favorited the picker. Other data may also be leveraged in training the favorite order prediction model 330, e.g., the picker's rating by customers, the picker's preferences (e.g., in retailer location, time-of-day to fulfill orders, average distance traveled to drop-off orders, etc.), the picker's interactions with the customers, other types of customer feedback, etc. Data may further include other contextual data 380, e.g., data relating to the customers that have favorited the picker, general supply and demand trends over the discretized time slots 320 (e.g., which may be crossed against specific retailer locations), other historical orders fulfilled in the same retailer location(s) serviced by the picker, etc. In some embodiments, the training module 260 may implement a feedback loop to retrain and tune the favorite order prediction module 330. For example, if TS₂ 324 is highly predicted to have a favorite order, but has twice failed to produce any favorite orders, then the training module 260 may utilize those negative reinforcement examples to downweight that particular time slot. On the other hand, for example, if TS₁ 322 is predicted to have a low likelihood of receiving a favorite order, but a customer client device 100 does generate a favorite order 370 for the picker, then the training module 260 may upweight that particular time slot.

### Exemplary Methods

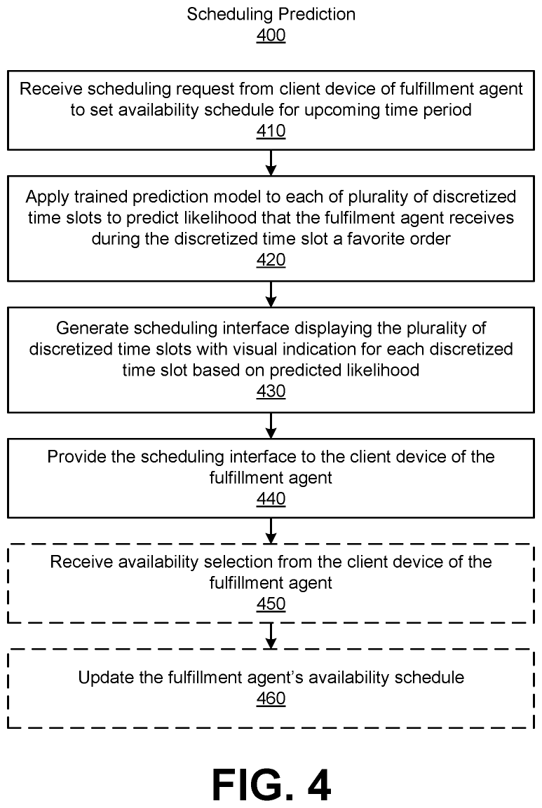

FIG. 4 is a flowchart describing the process of favorite order prediction 400 in the context of picker availability scheduling, in accordance with one or more embodiments. The description of FIG. 4 is in the perspective of an online system (e.g., the online concierge system 140), but in other embodiments, any computing system or device may perform any, some, or all of the steps.

The online system receives 410 a scheduling request from a client device of a fulfillment agent to set an availability schedule for a time period (e.g., forthcoming).

The online system applies 420 a trained prediction model to each of a plurality of discretized time slots of the time period to predict a likelihood that the fulfillment agent receives a favorite order during the discretized time slot. The fulfillment agent may be favorited by one or more requesting users, which may request a favorite order to be assigned to the fulfillment agent. The trained prediction model may be trained according to the profile of the fulfillment agent including historical order data. The trained prediction model may be further trained on other contextual data or fulfillment agent preference data.

The online system generates 430 a scheduling interface displaying the plurality of discretized time slots with a visual indication for each discretized time slot based on the predicted likelihood for that discretized time slot. The visual indication may be the predicted likelihood displayed adjacent or in proximity to the discretized time slot. The visual indication may also appear like a heat map with color coded time slots based on the predicted likelihoods. To generate such a heat map, the online system may apply a thresholding filter to the likelihoods to determine the color to display with each discretized time slot. For example, time slots with a likelihood above 75% may be colored green, time slots with a likelihood between 50% and 75% may be colored yellow, and time slots below 50% may be colored red.

The online system provides 440 the scheduling interface to the client device of the fulfillment device.

In additional embodiments, the online system may receive 450 the availability selection from the client device of the fulfillment agent. The availability selection includes, for each discretized time slot, an indication as to whether the fulfillment agent is available or unavailable.

The online system may update 560 the fulfillment agent's availability schedule, which would affect how requesting users who have favorited the fulfillment agent may thereby request and assign favorite orders to the fulfillment agent. As requesting users further utilize favorite orders with the fulfillment agent, the online system may collect data around the favorite orders to retrain and tune the trained prediction model.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor may comprise one or more sub-processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A computer-implemented method comprising:
receiving a request from a client device of a fulfillment agent;
based on receipt of the request, applying a trained prediction model to each of a plurality of discretized time slots of a time period to predict a likelihood that the fulfillment agent receives, during the discretized time slot, a favorite order from a requesting user that has favorited the fulfillment agent, wherein the trained prediction model is trained by:
retrieving a profile for the fulfillment agent comprising a list of one or more requesting users that have favorited the fulfillment agent, and
training the trained prediction model based on order histories of the one or more requesting users that have favorited the fulfillment agent;
generating an interface displaying the plurality of discretized time slots with a visual indication for each discretized time slot based on the predicted likelihood for the discretized time slot; and
providing, in response to the request, the interface to the client device of the fulfillment agent.

2. The method of claim 1, wherein generating the interface displaying the plurality of discretized time slots comprises displaying the likelihood for each discretized time slot.

3. The method of claim 1, wherein generating the interface displaying the plurality of discretized time slots comprises:
applying a thresholding filter to the likelihood of each discretized time slot to determine a display color as the visual indication; and
generating a heat map with the plurality of discretized time slots colored according to the determined display colors.

4. The method of claim 1, wherein generating the interface displaying the plurality of discretized time slots comprises:
identifying one or more of the discretized time slots as optimal time slots having highest likelihoods; and
visually distinguishing the optimal time slots in the scheduling interface.

5. The method of claim 1, wherein generating the interface displaying the plurality of discretized time slots comprises:
generating an option for each discretized time slot that, when selected, provides an indication that the fulfillment agent is available during that discretized time slot.

6. The method of claim 1, wherein the trained prediction model is further trained by:
retrieving user preference data for the fulfillment agent based on historical orders fulfilled for one or more requesting users during discretized time slots in prior periods, wherein at least one of the requesting users has favorited the fulfillment agent; and
training the prediction model with the user preference data to predict the likelihood that the fulfillment agent is favorited by a requesting user upon completion of an order request during a discretized time slot.

7. The method of claim 1, wherein the trained prediction model is further trained by:
retrieving other historical orders fulfilled by other fulfillment agents in one or more retailer locations where the fulfillment agent has also fulfilled historical orders, wherein the other historical order indicate which other historical order was favorited by the corresponding requesting user; and
training the prediction model with the other historical orders.
training the prediction model with the other historical orders.

8. The method of claim 1, further comprising:
receiving requesting user feedback on one or more new orders during a first discretized time slot in the time period fulfilled by the fulfillment agent, wherein at least one new order is favorited by the corresponding requesting user; and
retraining the trained prediction model with the one or more new orders and the likelihood of the first discretized time slot predicted by the trained prediction model.

9. The method of claim 1, wherein the request from the client device requests to set an availability schedule for the time period.

10. The method of claim 9, further comprising:
receiving, via the interface, an availability selection from the client device of the fulfillment agent indicating that the fulfillment agent is available for one or more of the discretized time slots; and
updating an availability schedule for the time period to reflect the availability of the fulfillment agent during the one or more discretized time slots.

11. A non-transitory computer-readable storage medium storing instructions that, when executed by a computer processor, cause the computer processor to perform operations comprising:
receiving a request from a client device of a fulfillment agent;
based on receipt of the request, applying a trained prediction model to each of a plurality of discretized time slots of a time period to predict a likelihood that the fulfillment agent receives, during the discretized time slot, a favorite order from a requesting user that has favorited the fulfillment agent, wherein the trained prediction model is trained by:
retrieving a profile for the fulfillment agent comprising a list of one or more requesting users that have favorited the fulfillment agent, and
training the trained prediction model based on order histories of the one or more requesting users that have favorited the fulfillment agent;
generating an interface displaying the plurality of discretized time slots with a visual indication for each discretized time slot based on the predicted likelihood for the discretized time slot; and
providing, in response to the request, the interface to the client device of the fulfillment agent.

12. The non-transitory computer-readable storage medium of claim 11, wherein generating the interface displaying the plurality of discretized time slots comprises displaying the likelihood for each discretized time slot.

13. The non-transitory computer-readable storage medium of claim 11, wherein generating the interface displaying the plurality of discretized time slots comprises:
applying a thresholding filter to the likelihood of each discretized time slot to determine a display color as the visual indication; and
generating a heat map with the plurality of discretized time slots colored according to the determined display colors.

14. The non-transitory computer-readable storage medium of claim 11, wherein generating the interface displaying the plurality of discretized time slots comprises:
identifying one or more of the discretized time slots as optimal time slots having highest likelihoods; and
visually distinguishing the optimal time slots in the scheduling interface.

15. The non-transitory computer-readable storage medium of claim 11, wherein generating the interface displaying the plurality of discretized time slots comprises:
generating an option for each discretized time slot that, when selected, provides an indication that the fulfillment agent is available during that discretized time slot.

16. The non-transitory computer-readable storage medium of claim 11, wherein the trained prediction model is further trained by:
retrieving user preference data for the fulfillment agent based on historical orders fulfilled for one or more requesting users during discretized time slots in prior periods, wherein at least one of the requesting users has favorited the fulfillment agent; and
training the prediction model with the user preference data to predict the likelihood that the fulfillment agent is favorited by a requesting user upon completion of an order request during a discretized time slot.

17. The non-transitory computer-readable storage medium of claim 11, wherein the trained prediction model is further trained by:
retrieving other historical orders fulfilled by other fulfillment agents in one or more retailer locations where the fulfillment agent has also fulfilled historical orders, wherein the other historical order indicate which other historical order was favorited by the corresponding requesting user; and
training the prediction model with the other historical orders.

18. The non-transitory computer-readable storage medium of claim 11, the operations further comprising:
receiving requesting user feedback on one or more new orders during a first discretized time slot in the time period fulfilled by the fulfillment agent, wherein at least one new order is favorited by the corresponding requesting user; and
retraining the trained prediction model with the one or more new orders and the likelihood of the first discretized time slot predicted by the trained prediction model.

19. The non-transitory computer-readable storage medium of claim 11, wherein the request from the client device requests to set an availability schedule for the time period.

20. The non-transitory computer-readable storage medium of claim 11, the operations further comprising:
receiving, via the interface, an availability selection from the client device of the fulfillment agent indicating that the fulfillment agent is available for one or more of the discretized time slots; and
updating the availability schedule for the time period to reflect the availability of the fulfillment agent during the one or more discretized time slots.
